(19) United States
(12) Patent Application Publication
(10) Pub. No.: US 2025/0392793 A1
(43) Pub. Date: Dec. 25, 2025

(54) METHOD, APPARATUS, DEVICE, MEDIUM, AND PRODUCT FOR CROSS-LANGUAGE VIDEO PROCESSING

(71) Applicants: Beijing Zitiao Network Technology Co., Ltd., Haidian District, Beijing (CN); DOUYIN VISION CO., LTD., Shijingshan District, Beijing (CN)

(72) Inventors: Da Man, Beijing (CN); Jianhua Jiang, Beijing (CN); Kaixuan Xiao, Beijing (CN)

(21) Appl. No.: 18/877,496

(22) PCT Filed: Nov. 21, 2023
(86) PCT No.: PCT/CN2023/132848

§ 371 Date: Dec. 20, 2024

(30) Foreign Application Priority Data
Dec. 29, 2022 (CN) 202211716609.X

(51) Int. Cl. H04N 21/81; G06F 40/58; G11B 27/031; H04N 21/233; H04N 21/242; H04N 21/485

(52) U.S. Cl. CPC H04N 21/8106; G06F 40/58; G11B 27/031; H04N 21/233; H04N 21/242; H04N 21/4856

(57) ABSTRACT

Embodiments of the disclosure provide methods, apparatuses, a device, a medium, and a product for cross-language video processing. The method includes: in response to a video playing request by a first user, determining a video to be played, the video to be played being a video posted by a second user; determining a video file associated with the video to be played, and at least one translation file, the at least one translation file being obtained based on an original audio file of the video to be played being translated according to a respective language type of at least one language type, and the original audio file and the video file being obtained by decoupling the video to be played; determining a target translation file matching play demand information of the first user, according to the respective language type corresponding to the at least one translation file; and downloading the target translation file from a target server corresponding to the target language type, and synchronously playing the video file and the target translation file. The problem of low efficiency in video cross-language processing is solved.

The present application claims priority to Chinese Patent Application No. 202211716609.X, filed on Dec. 29, 2022, and entitled “METHOD, APPARATUS, DEVICE, MEDIUM, AND PRODUCT FOR CROSS-LANGUAGE VIDEO PROCESSING”, the entirety of which is incorporated herein by reference.

### FIELD

Embodiments of the present disclosure relate to the field of computer, and in particular, to methods, apparatuses, a device, a medium, and a product for cross-language video processing.

### BACKGROUND

In practical applications, videos may be classified into long videos and short videos based on their playing duration. A video playing program may play a video, for example, a relatively common short video, for a user. Different countries or regions have different language types, therefore it is necessary to provide videos in corresponding languages for users in different regions, that is, there is a need for cross-language playing of a video.

The current common approach for cross-language video playing is to set videos in different languages for the same video content. That is, a video can be set into respective videos in multiple languages. This results in a relatively rigid approach for cross-language video playing, requiring an individual setting up of videos in various languages, thereby the efficiency of cross-language video processing is low.

### SUMMARY

The embodiments of the present disclosure provide methods, apparatuses, a device, a medium, and a product for cross-language video processing, to solve the problem that a video requires coupling with fixed audio, resulting in a high demand for video storage.

In a first aspect, an embodiment of the present disclosure provides a method of cross-language video processing, comprising:
in response to a video playing request by a first user, determining a video to be played, the video to be played being a video posted by a second user;
determining a video file associated with the video to be played, and at least one translation file, the at least one translation file being obtained based on an original audio file of the video to be played being translated according to a respective language type of at least one language type, and the original audio file and the video file being obtained by decoupling the video to be played;
determining a target translation file matching play demand information of the first user, according to the respective language type corresponding to the at least one translation file; and
downloading the target translation file from a target server corresponding to the target language type, and synchronously playing the video file and the target translation file.

In a second aspect, an embodiment of the present disclosure provides a method of cross-language video processing, comprising:
in response to a video posting request by a second user, determining a video to be posted;
decoupling the video to be posted, to obtain an original audio file and a video file;
converting the original audio file into a translation file based on a respective language type of at least one language type to obtain at least one translation file;
posting the video file, the original audio file and the at least one translation file, to store the at least one translation file in a server matching the respective language type corresponding to the at least one translation file; and
wherein the video file and a target translation file of the at least one translation file are used for synchronous play in response to a cross-language video processing request by a first user, and the target translation file matches a play demand of the first user.

In a third aspect, an embodiment of the present disclosure provides an apparatus for cross-language video processing, comprising:
a first responding unit configured to, in response to a video playing request by a first user, determine a video to be played, the video to be played being a video posted by a second user;
a file determining unit configured to determine a video file associated with the video to be played, and at least one translation file, the at least one translation file being obtained based on an original audio file of the video to be played being transmitted according to a respective language type of at least one language type, and the original audio file and the video file being obtained by decoupling the video to be played;
a language matching unit configured to determine a target translation file matching play demand information of the first user, according to the respective language type corresponding to the at least one translation file; and
a file processing unit configured to download the target translation file from a target server corresponding to the target language type, and synchronously play the video file and the target translation file.

In a fourth aspect, an embodiment of the present disclosure provides an apparatus for cross-language video processing, comprising:
a second responding unit configured to, in response to a video posting request by a second user, determine a video to be posted;
a video decoupling unit configured to decouple the video to be posted, to obtain an original audio file and a video file;
a file translation unit configured to convert the original audio file into a translation file based on a respective language type of at least one language type, to obtain at least one translation file;
a video posting unit configured to posting the video file, the original audio file and the at least one translation file, to store the at least one translation file in a server matching the respective language type corresponding to the at least one translation file; and
wherein the video file and a target translation file of the at least one translation file are used for synchronous play in response to a cross-language video processing request by a first user, and the target translation file matches a play demand of the first user.

In a fifth aspect, an embodiment of the present disclosure provides an electronic device, comprising a processor and a memory;
the memory storing computer-executable instructions;
the processor executing the computer-executable instructions stored in the memory, causing the processor to configure the method of cross-language video processing according to the first aspect and various possible designs of the first aspect.

In a sixth aspect, an embodiment of the present disclosure provides a computer-readable storage medium, wherein the computer-readable storage medium stores computer-executable instructions which, when executed by a processor, implement the method of cross-language video processing according to the first aspect and various possible designs of the first aspect.

In a seventh aspect, an embodiment of the present disclosure provides a computer program product comprising a computer program, wherein the computer program is executed by a processor to configure the method of cross-language video processing according to the first aspect and various possible designs of the first aspect.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is an application network architecture diagram of a method of cross-language video processing according to an embodiment of the present disclosure;

FIG. 2 is a flowchart of a method of cross-language video processing according to an embodiment of the present disclosure;

FIG. 3 is an example diagram of a video playing interface according to an embodiment of the present disclosure;

FIG. 4 is an example diagram of obtaining a target translation file according to an embodiment of the present disclosure;

FIG. 5 is a flowchart of another embodiment of a method of cross-language video processing according to an embodiment of the present disclosure;

FIG. 6 is a schematic structural diagram of an apparatus for cross-language video processing according to an embodiment of the present disclosure;

FIG. 7 is a schematic structural diagram of an apparatus for cross-language video processing according to an embodiment of the present disclosure; and

FIG. 8 is a schematic diagram of a hardware structure of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. It is apparent that the drawings in the following description are some embodiments of the present disclosure, rather than all of the embodiments. All other embodiments obtained by those skilled in the art based on the embodiments of the present disclosure without creative efforts shall fall within the scope of the present disclosure.

The technical solution of the present disclosure may be to a cross-language video playing scenario, the audio corresponding to a video is converted into at least one translation file, which is stored in the respective server in a form of translation file. The translation file is rapidly distributed to respective users through different servers, the effect of quickly allocating the translation file for the user to realize synchronous playing of the video file and the target translation file is achieved, and the efficiency of cross-language video processing is improved.

In the related art, in a cross-language video playing scenario, generally after a video is posted, the video may be viewed by users in different regions, so that the video needs to be converted into languages of users in different regions, which generates a cross-language video playing scenario. At present, a common cross-language video processing manner is to couple a respective audio file of multiple audio files of a video with a video file, to obtain a video corresponding to a respective language type of multiple language types. When a user needs to view a video of a certain language type, a video of a related language may be pushed to the user. In this manner, the audio file of respective language types is coupled to the video, so that the video can only be processed from the video dimension, while the processing efficiency of the video in the cross-language scenario is low.

In order to solve the above technical problem, the inventor considers that a video is decoupled, and a plurality of translated files of a plurality of language types obtained by translation are separately stored, so that a video file may be associated with at least one translation file. By storing the video file and the translation file separately, the space occupation of the video can be effectively reduced. In addition, the at least one translation file may be separately stored, that is, the at least one translation file is stored in a server located in the region corresponding to the language type of respective translation files, thereby improving the distribution efficiency of the translation file. By converting the original audio file into the at least one translation file, and distributing the corresponding translation file according to user demand, cross-language processing of the video is achieved, and the efficiency of cross-language video processing is improved.

In an embodiment of the present disclosure, in response to a video playing request by a first user, a video to be played is determined. The video to be played is a video posted by a second user. In other words, the video posted by the second user may be played by an electronic device of the first user. The electronic device further obtains a video file associated with the video to be played, and at least one translation file. The at least one translation file is obtained based on an original audio file of the video to be played being translated according to a respective language type of at least one language type, to implement cross-language translation on the original audio file to obtain the at least one translation file. After that, a target translation file matching play demand information of the first user is determined, according to the respective language type corresponding to the at least one translation file. The target translation file is downloaded from a target server corresponding to the target language type, and the video file and the target translation file are synchronously played. Rapid acquisition of the target translation file can be achieved through the target server. For a video, the playing of at least one translation file may be provided for the user, thereby achieving cross-language processing of the video, and improving the efficiency of video playing under multiple language scenarios.

The technical solutions of the present disclosure and how the technical solutions of the present disclosure solve the above technical question will be described in detail below with reference to specific embodiments. The following specific embodiments may be combined with each other, and the same or similar concepts or processes may not be repeated in some embodiments. Embodiments of the present invention will be described in detail below with reference to the accompanying drawings.

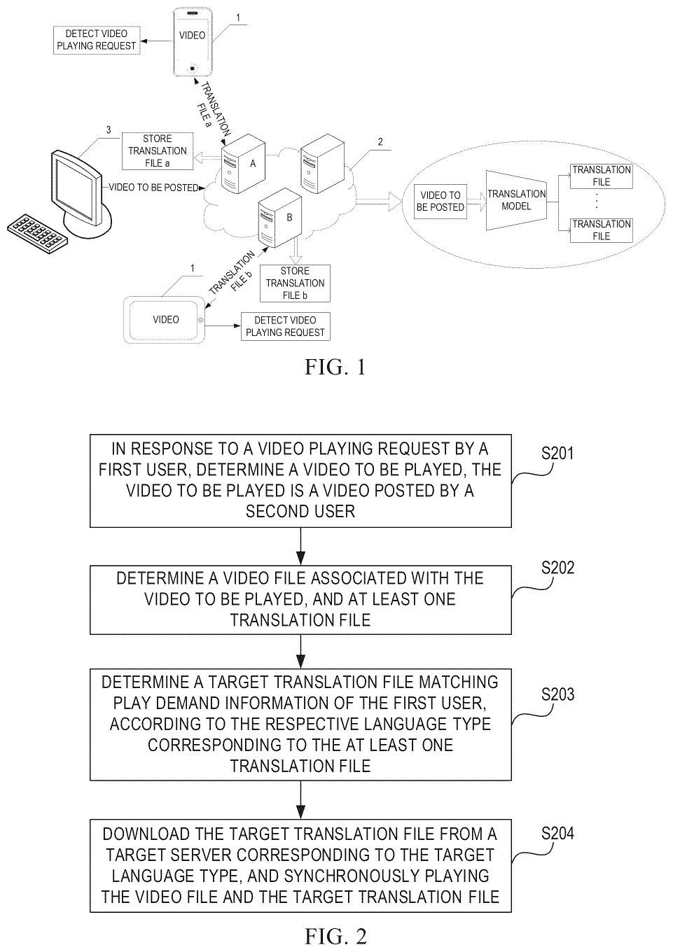

FIG. 1 is an application network architecture diagram of a method of cross-language video processing according to the present disclosure. The application network architecture according to the embodiments of the present disclosure may include a first electronic device 1, and a server cluster 2 connected to the electronic device 1 through a local area network or a wide area network, where the server cluster 2 may be a common server cluster, a super computer cluster, a cloud server cluster, or the like. In addition, the network architecture further includes a second electronic device 3. The second electronic device 3 may establish a connection with the server cluster 2. A second user may post a video to the server cluster through the second electronic device 3.

The server cluster 2 may obtain a video to be posted, decouple a video file of the video to be posted and an original audio file, and may sequentially translate the original audio file into a translation file according to at least one language type, to obtain at least one translation file. The server cluster 2 may include at least one server 21, and respective servers are distributed in different regions. The language types applicable to respective regions are different. For example, server A may be located in a region of language type A, and is configured to store translation file a of the language type A, server B may be located in a region of language type B, and is configured to store translation file b of the language type B, and so on.

The first electronic device 1, for example, may comprise a device such as a mobile phone 11, a personal computer (not shown in the figure), a notebook computer (not shown in the figure), a tablet computer 12, and so on. A specific type of the electronic device 1 in the embodiments of the present disclosure is not limited. It is assumed that the language used by the first user is language A, and the first electronic device 11 may be located in the coverage of the server A. The first electronic device 11 may determine a video to be played, in response to a video playing request by the first user. A video file associated with the video to be played, and at least one translation file are obtained, and then a target translation file matching a play demand of the first user is determined according to the respective language type corresponding to the at least one translation file, that is, target translation file a corresponding to the language A. Then, the target translation file a is downloaded from the target server A corresponding to the target language type. For the second electronic device 12, a video to be played may be determined in response to a video playing request by the second user. By obtaining a video file associated with the video to be played and at least one translation file, a target translation file matching the play demand of the first user, that is, target translation file B corresponding to speech B, may be determined according to the respective language type corresponding to the at least one translation file. Further, target translation file b may be downloaded from target server B corresponding to the target language type.

Therefore, in this solution, the distribution of the server corresponds to the language type, the translation file corresponding to the respective language type is stored in the corresponding server, the target translation file may be determined for the first user after the play demand information of the first user is determined, to achieve the quick downloading of the target translation file. After downloading the target translation file, the video file and the target translation file may be synchronously played. By separately storing the translation file and the video file, the efficiency of cross-language video processing may be effectively improved, the flexible cross-language video display may be achieved, and the efficiency of cross-language video playing is improved.

Certainly, the system architecture shown in FIG. 1 is merely an example, and should not constitute a specific limitation on the structure of the system architecture of the technical solutions of the present disclosure. In practical applications, the first electronic device or the second electronic device may further comprise a Client/Server (CS) architecture or the like, to form a more complex overall system architecture, which will not be enumerated herein.

Reference is made to FIG. 2, which is a flowchart of a method of cross-language video processing according to an embodiment of the present disclosure. The method may be configured in an apparatus for cross-language video processing, and the apparatus for cross-language video processing may be located in an electronic device. The method of cross-language video processing may comprise the following steps.

Step 201: in response to a video playing request by a first user, a video to be played is determined. The video to be played is a video posted by a second user.

Alternatively, the execution body of the technical solution of the present disclosure may be an electronic device. The electronic device may be a user-oriented terminal device, such as an electronic device such as a mobile phone, a tablet computer, or the like. The electronic device may further be a server, and the server may provide a video playing service for the first user, and through the information interaction with the user terminal of the first user, receiving of the video playing request and feedback of the video file and the target translation file can be implemented.

The electronic device may provide a video playing function for the first user. The video to be played may be sent by the second user to the server cluster through the second electronic device for storage.

The video to be played may comprise a video file and an original audio file. The video file may refer to a video corresponding to an image in the video to be played. The original audio file may refer to an audio file corresponding to an audio track of the video to be played. The audio track may refer to a parallel track visible when examining sound through sound editing software, and each track allows for a definition of a property of the track, such as a timbre, a timbre library, a number of channels, an input/output port, a volume, and the like.

The video playing request may be triggered by the first user. A video playing interface may be provided, and the video playing request may be generated in response to video playing triggered by the first user. In a possible design, the video playing request may include video information of the video to be played, to determine the video to be played based on a play demand of the user. In another possible design, in the process of a video being played in the video playing interface, the first electronic device may detect sliding performed by the first user, and generate a video playing request. Video information of the video to be played may not be set in the video playing request. In this case, the video playing request may be sent to a server of a video playing program, and the server may respond to the first electronic device with the video to be played.

Step 202: a video file associated with the video to be played, and at least one translation file are determined. The at least one translation file is obtained based on an original audio file of the video to be played being translated according to a respective language type of at least one language type. The original audio file and the video file are obtained by decoupling the video to be played.

Alternatively, after determining the video file associated with the video to be played at step 202, the video file of the video to be played may be downloaded. The video file may be precached, that is, the video file is divided into a plurality of video frames and may be downloaded frame by frame. In practical applications, a real-time download real-time playing manner may be applied, and the video frames may be sequentially downloaded according to the playing order and played sequentially according to the playing order.

The translation file may comprise a subtitle file or a track audio file. The subtitle file may be obtained by performing subtitle conversion on the text corresponding to the original audio file. The track audio file may be obtained by performing voice conversion on the text corresponding to the original audio file.

Alternatively, a video may include a video identifier, and different videos may be distinguished by the video identifier. The video identifier may comprise the number or name of the video. Determining the video file associated with the video to be played and the at least one translation file may refer to determining a video file identifier of the video file associated with a video identifier of the video to be played and a respective translation file identifier of the at least one translation file. The video file identifier and the translation file identifier may comprise the number or name of the file.

Step 203: a target translation file matching play demand information of the first user is determined according to the respective language type corresponding to the at least one translation file.

Alternatively, the translation file may have a mapping relationship with its corresponding language type. The play demand information of the first user may refer to obtained information of a language type used by the first user when playing the video to be played.

Step 204: the target translation file is downloaded from a target server corresponding to the target language type, and the video file and the target translation file are synchronously played.

Alternatively, the at least one translation file may be stored in at least one server of a server cluster. Respective servers may be distributed in different regions, and servers corresponding to different regions may store translation files of corresponding language types.

Specifically, downloading the target translation file at step 204 may comprise: determining, from at least one server storing the at least one translation file of the server cluster, a target server corresponding to the target language type, and downloading the target translation file from the target server.

In the embodiments of the present disclosure, in response to a video playing request by a first user, a video to be played may be determined. The video to be played is a video posted by a second user. Playing of the posted videos is achieved. The at least one translation file may be obtained based on an original audio file of the video to be played being translated according to a respective language type of at least one language type, and the original audio file and the video file are obtained by decoupling the video to be played, thereby implementing cross-language processing on the video to be played according to the at least one language type. A target translation file matching play demand information of the first user is determined according to the respective language type corresponding to the at least one translation file, to implement adaptive acquisition of the target translation file according to the play demand of the user. After that, the target translation file is downloaded from a target server corresponding to the target language type. By synchronously playing the video file and the target translation file, the video can be played according to the play demand of the user. For the cross-language video processing scenario, the video can be played according to a personalized language type, thereby improving the efficiency of cross-language video processing.

Further, alternatively, based on the above embodiments, determining the target language type matching the play demand information of the first user, according to the respective language type corresponding to the at least one translation file comprises:
displaying the at least one language type on a playing interface of the video to be played; and
in response to selecting by the first user on the at least one language type, obtaining the target language type selected by the first user.

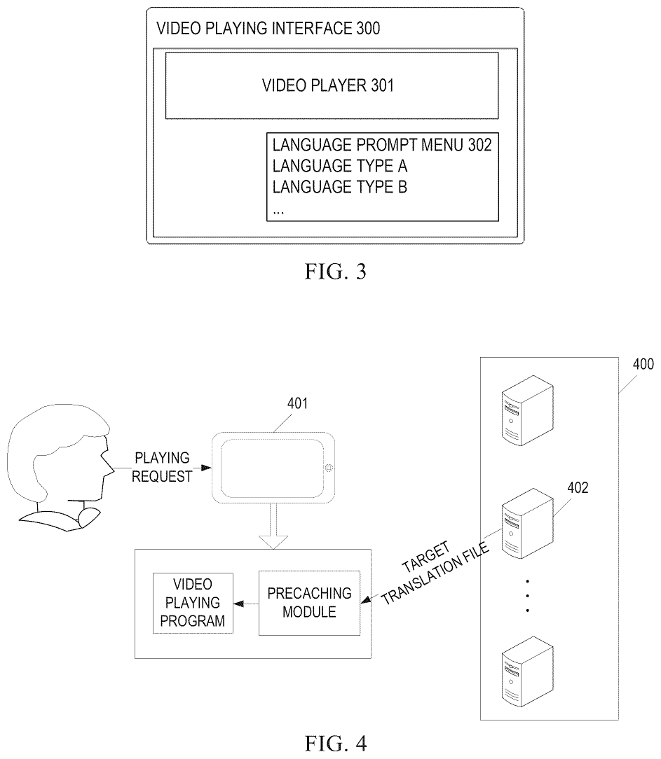

Alternatively, the video playing interface of the video to be played may be, for example, as shown in FIG. 3, a video playing interface 300 may include a video player 301, a language prompt menu 302, and the language prompt menu 302 may display at least one language type, for example, language type A and language type B as shown in 302.

The selecting may be a clicking by the user for any of the at least one language type. The target language type may be a language type selected by the first user.

Alternatively, after the video to be played is determined, the video to be played may start being played, that is, an audio segment of the original audio file and a video segment of the video file of the video to be played may be downloaded, and after coupling the audio segment of the original audio file and the video segment of the video file to obtain a complete video segment, the video segment may be played to obtain a playing interface of the video to be played. The playing interface may be a playing interface of a video segment of the video to be played. In the process of playing the video to be played, at least one language type may be displayed to detect selection by the first user for the target language type of the at least one language type, so that switching the translation file of the video in real-time in the video playing process is achieved. Further, when the language of the video to be played is inconsistent with the user demand, language switching is implemented according to the user demand, thereby improving the user experience.

In the embodiments of the present disclosure, the at least one language type may be displayed on a playing interface of the video to be played to detect selecting by the first user on any language type, to obtain the target language type selected by the first user. By displaying the language type for the first user, a video personalized playing function in the cross-language scenario is realized, a visual display of the cross-language playing is provided, and the playing efficiency of cross-language video is improved.

Further, alternatively, based on the above embodiments, determining the target language type matching the play demand information of the first user, according to the respective language type corresponding to the at least one translation file comprises:
determining an application language of the first user according to user information of the first user; and
determining the target language type as a language type of the application language, according to the respective language type corresponding to the at least one translation file.

The user information may comprise location information of the user, a language type selected by the user when using the electronic device, or a historical language type selected by the user. The target language type matched with the use habit of the user may be accurately determined through the user information.

In the embodiments of the present disclosure, the application language of the first user may be determined according to the user information of the first user, and then the target language type as the language type of the application language is determined according to the respective language type corresponding to the at least one translation file. The automatic acquisition of the target language type is realized, and the target language type is automatically associated with the application language of the user, thereby improving the acquisition efficiency and accuracy of the target language type.

Further, alternatively, on the basis of any of the foregoing embodiments, the translation file comprises a track audio file, and determining the video file associated with the video to be played, and the at least one translation file comprises:
in accordance with a determination that the video to be played has multi-track playing permission, determining the video file associated with the video to be played, and at least one track audio file.

Alternatively, in accordance with a determination that the video to be played does not have the multi-track playing permission, the video to be played may be directly played. That is, the original audio file and the video file may be downloaded, and the original audio file and the video file are coupled and then played.

Alternatively, the multi-track playing permission may refer to use permission of a user to use the at least one translation file. In a possible design, in accordance with a determination that the video to be played has associated with the at least one translation file, it may be determined that the video to be played has playing permission. Certainly, if it is detected that the language type of the original audio file of the video to be played does not match the language type of the first user, a start prompt window of the multi-track playing permission may be output, and if confirmation by the first user for the multi-track playing permission is detected, the multi-track playing permission of the video to be played may be started.

In the embodiments of the present disclosure, if the translation file is a track audio file, the video file associated with the video to be played and the at least one track audio file may be obtained when determining the video to be posted has the multi-track playing permission. By implementing the multi-track playing permission, a restriction is applied to the use of multi-track in the video to be played, the security of using the track audio file is ensured.

Further, alternatively, based on the foregoing embodiments, the method further comprises:
displaying a multi-track switch on a playing interface of the video to be played; and
in response to triggering by the first user on the multi-track switch, determining that the video to be played has multi-track play permission, the multi-track play permission being used to enable playing permission of a track audio file of the video to be played, corresponding to a respective language type of the at least one language type.

Alternatively, the multi-track switch may be displayed in a process of playing the original audio file and the video file of the video to be played.

The track audio file may refer to an audio file defined by an audio track, and the audio file may be played through the audio track.

In the embodiments of the present disclosure, through displaying the multi-track switch on the playing interface of the video to be played, the video to be played has multi-track play permission is determined in response to triggering by the first user on the multi-track switch. By interacting with the user, the user can control the playing function of a cross-language video, and the corresponding playing service is provided for the user according to the user demand, thereby improving the user experience.

Further, alternatively, based on any of the above embodiments, the method further comprises before downloading the target translation file matching the target language type, from the target server corresponding to the target language type:
in accordance with a determination, by querying, that a target translation file corresponding to the target language type is stored in a local server, determining that the local server is the target server.

Alternatively, the local server may be a server communicatively connected to the electronic device of the first user and configured to parse a Domain Name System (DNS) link corresponding to the electronic device. The communication distance between the local server and the electronic device is short, and if the target translation file is already stored in the local server, the local server may be directly determined as the target server, so that the target translation file can be quickly downloaded, and the efficiency of file downloading is improved.

In the embodiments of the present disclosure, after the target translation file is determined, whether the target translation file exists in the local server may be confirmed. If the target translation file exists in the local server, the local server may be determined as the target server, so that localization of the target server can be realized, the transmission distance of the translation file may be effectively reduced, and the transmission efficiency of the translation file is improved.

Further, alternatively, based on any of the above embodiments, the method further comprises before downloading the target translation file from the target server corresponding to the target language type:
querying at least one server associated with the target language type of the video to be played; and
determining, from the at least one server, a target server with a minimum transmission distance from the first user.

Alternatively, in practical applications, in order to relieve the processing pressure of a region, at least one server may be set in a language region, for example, the region in the Chinese territory range may be divided into a plurality of sub-regions, including a north sub-region, a northeast sub-region, a southwest sub-region, a southeast sub-region, and the like. The respective sub-regions may respectively store a Chinese translation file. Therefore, after determining the target language type, at least one server associated with the target language type of the video to be played may be determined. The at least one server associated with the target language type may store the target translation file, respectively.

Alternatively, the minimum transmission distance may be a minimum physical transmission distance or a minimum network transmission, and transmission time between the target server and the electronic device of the first user may be minimized through the server with the minimum transmission distance.

For ease of understanding, as an example of obtaining the target translation file shown in FIG. 4, an electronic device 401 may establish a connection with a server cluster 400. After the first user initiates a playing request, for the video to be played, to the server cluster 400 through the electronic device 401, a server 402 in the server cluster 400 may be the target server with the minimum transmission distance from the electronic device 401. Therefore, the server 402 may provide feedback on the target translation file to the electronic device. Specifically, the electronic device 401 may cache the target translation file through a cache module and implement coupling of the target translation file and the video file by using a video playing program, to achieve synchronous playing of the target translation file and the video file.

In the embodiments of the present disclosure, at least one server associated with the target language type of the video to be played is queried, and a target server with a minimum transmission distance from the first user is determined from the at least one server. The transmission distance of the target translation file is minimized, the file transmission cost can be effectively reduced, and the transmission efficiency of the target translation file is improved.

Further, alternatively, based on any of the above embodiments, downloading the target translation file from the target server corresponding to the target language type comprises:
determining, according to the target server, a target download address of the video to be played, corresponding to the target translation file; and
downloading the target translation file using the target download address.

Alternatively, the target download address may be a storage address of the target translation file at the target server. The target download address may be obtained by combining the access path of the target server and the access path of the target translation file on the target server.

The access address corresponding to the file identifier of the file in the target server that is the same as the file identifier of the target translation file may be queried to obtain the target download address. Certainly, a generation rule of the download address of the translation file may also be predetermined, and the target download address of the target translation file is generated in real-time by using the generation rule of the download address, to achieve the real-time generation of the target download address.

In the embodiments of the present disclosure, a target download address of the video to be played, corresponding to the target translation file is determined according to the target server, and the target translation file is downloaded using the target download address. By determining the download address of the target translation file at the target server, the download of the target translation file may be quickly and accurately completed.

Further, alternatively, based on any of the above embodiments, downloading the target translation file matching the target language type and synchronously playing the video file and the target translation file comprises:
determining at least one translation file segment of the target translation file matching the target language type and a segment order corresponding to a respective translation file segment of the at least one translation file segment;
sequentially downloading, by precaching, the translation file segment based on the segment order of the respective translation file segment;
coupling the downloaded translation file segment to a video file segment corresponding to the video file to obtain a target video segment, the downloaded translation file and the video file segment having a same timestamp; and
playing the target video segment to synchronously play the translation file segment in the target translation file and the video file segment in the video file.

Alternatively, a precaching module may be used to download the translation file segment of the target translation file.

Alternatively, the translation file segment may be a file frame, for example, if the translation file is an audio file, the file frame may be an audio frame. The video file segment may be at least one video frame, and the timestamp of the at least one video frame and the same timestamp of the audio frame are coupled to obtain the target video segment.

In the embodiments of the present disclosure, the translation file segment corresponding to the target translation file matching the target language type may be sequentially downloaded by precaching, and the downloaded translation file segment is coupled to a video file segment corresponding to the video file to obtain a target video segment, where the downloaded translation file and the video file segment have a same timestamp. By coupling the translation file segment and the video file segment, the target video segment containing the voice and the video picture may be obtained. The translation file segment in the target translation file and the video file segment in the video file may be synchronously played by playing the target video segment. Synchronous playing of the segments may be realized through segment coupling, synchronously playing of the voice and the picture in a cross-language video playing scenario is enhanced, and user experience is improved.

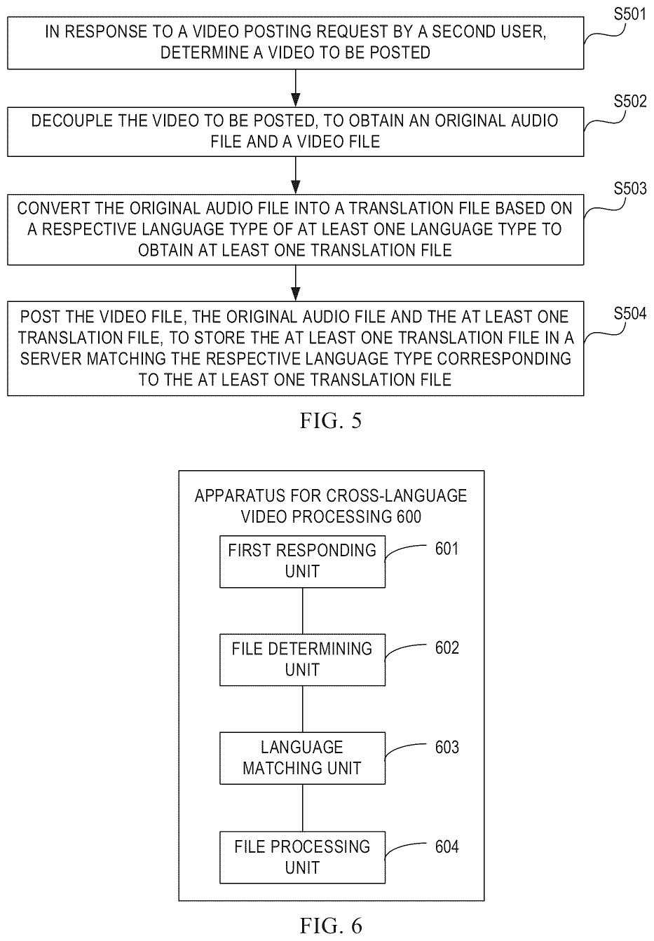

FIG. 5 is a flowchart of another embodiment of the method of cross-language video processing according to an embodiment of the present disclosure. The method of cross-language video processing may comprise the following steps.

Step 501: In response to a video posting request by a second user, a video to be posted is determined.

Alternatively, a server may detect the video posting request sent by the electronic device of the second user, and receive the video to be posted sent by the electronic device of the second user. The video to be posted may be sent by the electronic device of the second user to the server.

Step 502: the video to be posted is decoupled, to obtain an original audio file and a video file.

Alternatively, step 502 may specifically comprise: extracting the original audio file and the video file from the video to be posted to obtain the original audio file and the video file. The video file may be a video picture formed by an image frame of the video to be posted. The original audio file may be a signal corresponding to an audio track of the video to be posted.

Step 503: the original audio file is converted into a translation file based on a respective language type of at least one language type to obtain at least one translation file.

Alternatively, the language of the original audio file may be any language. At least one language type may be predetermined, and a translation model corresponding to each language type is obtained by training. After character recognition is performed on the original audio file, an original text file is obtained, and the original text file is translated through a translation model corresponding to the respective language type, to obtain at least one text translation file.

In a possible design, a subtitle file may be generated using the text translation file obtained by the translation model, and the subtitle file is determined as a translation file.

In still another possible design, a track audio file may be generated by the text translation file obtained by the translation model, and the track audio file is determined as a translation file. That is, the text is converted into audio.

Alternatively, after determining the original audio file, a plurality of candidate language types may be output, and at least one language type selected by the second user for the plurality of candidate language types may be detected. A selection by the second user for at least one language type that can be translated is implemented, and a personalized translation setting is achieved.

Step 504: The video file, the original audio file and the at least one translation file are posted, to store the at least one translation file in a server matching the respective language type corresponding to the at least one translation file; and
wherein the video file and a target translation file of the at least one translation file are used for synchronous play in response to a cross-language video processing request by a first user, and the target translation file matches a play demand of the first user.

In the embodiments of the present disclosure, after the video posting request by the second user, the video to be posted is determined. After decoupling the video to be posted, an original audio file and a video file are obtained. The original audio file may be converted into a translation file based on a respective language type of at least one language type to obtain at least one translation file. The video file, the original audio file and the at least one translation file may be posted by obtaining the at least one translation file. The at least one translation file is stored in a server matching the respective language type corresponding to the at least one translation file. Distributed posting of the at least one translation file generated in a cross-language video processing scenario is implemented, so that at the least one translation file may be used by the first user to obtain the target translation file therein, efficient matching and rapid issuing of the target translation file and the play demand of the first user are achieved, and the obtaining efficiency and accuracy of the target translation file are improved.

Further, alternatively, based on any of the above embodiments, storing the at least one translation file in the server matching the respective language type corresponding to the at least one translation file comprises:
determining a language application region corresponding to a respective translation file of the at least one translation file, according to the language type corresponding to the respective translation file;
querying a server associated with the language application region corresponding to the respective translation file; and
sending the respective translation file to the server associated with the corresponding language application region.

Alternatively, the language application region corresponding to a respective translation file of the at least one translation file may be a region of a language type corresponding to the translation file, and may comprise a country region, an administrative region of all levels in a country, and the like, and may be specifically divided according to the distribution of the server cluster. The server associated with the language application region corresponding to a respective translation file of the at least one translation file may be at least one.

In the embodiments of the present disclosure, a language application region corresponding to a respective translation file of the at least one translation file may be determined, according to the language type corresponding to the respective translation file. The respective language application region may be respectively associated with a server, therefore the respective translation file is sent to the server associated with the corresponding language application region, to implement distribution and storage of the respective translation file according to the language type corresponding to the respective translation file. Therefore, the translation may be completed in the early stage of video posting, and in the cross-language scenario, the video posting efficiency and accuracy can be improved.

FIG. 6 is a schematic structural diagram of an embodiment of an apparatus for cross-language video processing according to an embodiment of the present disclosure. The apparatus for cross-language video processing 600 may comprise:
a first responding unit 601 configured to, in response to a video playing request by a first user, determine a video to be played, the video to be played being a video posted by a second user;
a file determining unit 602 configured to determine a video file associated with the video to be played, and at least one translation file, the at least one translation file being obtained based on an original audio file of the video to be played being transmitted according to a respective language type of at least one language type, and the original audio file and the video file being obtained by decoupling the video to be played;
a language matching unit 603 configured to determine a target translation file matching play demand information of the first user, according to the respective language type corresponding to the at least one translation file; and
a file processing unit 604 configured to download the target translation file from a target server corresponding to the target language type, and synchronously play the video file and the target translation file.

As an embodiment, the language matching unit comprises:
a type displaying module configured to display the at least one language type on a playing interface of the video to be played; and
a type selecting module configured to, in response to selecting by the first user on the at least one language type, obtain the target language type selected by the first user.

As an embodiment, the language matching unit comprises:
an application determining module configured to determine an application language of the first user according to user information of the first user; and
a type determining module configured to determine the target language type as a language type of the application language, according to the respective language type corresponding to the at least one translation file.

As an embodiment, the translation file comprises a track audio file, and the file determining unit comprises:
a permission determining module configured to, in accordance with a determination that the video to be played has multi-track playing permission, determine the video file associated with the video to be played, and at least one track audio file.

As an embodiment, the apparatus further comprises:
a switch displaying unit configured to display a multi-track switch on a playing interface of the video to be played; and
a permission obtaining module unit configured to, in response to triggering by the first user on the multi-track switch, determine that the video to be played has multi-track play permission. The multi-track play permission is used to enable playing permission of a track audio file of the video to be played, corresponding to a respective language type of the at least one language type.

As an embodiment, the apparatus further comprises:
a first determining unit configured to, in accordance with a determination, by querying, that a target translation file corresponding to the target language type is stored in a local server, determining that the local server is the target server.

As an embodiment, the apparatus further comprises:
a type querying unit configured to query at least one server associated with the target language type of the video to be played; and
a second determining unit configured to determine, from the at least one server, a target server with a minimum transmission distance from the first user.

As an embodiment, the file processing unit comprises:
an address determining module configured to determine, according to the target server,
a target download address of the video to be played, corresponding to the target language type; and
a target downloading module configured to download the target translation file using the target download address.

As an embodiment, the file processing unit comprises:
a segment determining module configured to determine at least one translation file segment of the target translation file matching the target language type and a segment order corresponding to a respective translation file segment of the at least one translation file segment;
a file caching module configured to sequentially download, by precaching, the translation file segment based on the segment order of the respective translation file segment;
a video coupling module configured to couple the downloaded translation file segment to a video file segment corresponding to the video file to obtain a target video segment, the downloaded translation file and the video file segment having a same timestamp; and
a video playing module configured to play the target video segment to synchronously play the translation file segment in the target translation file and the video file segment in the video file.

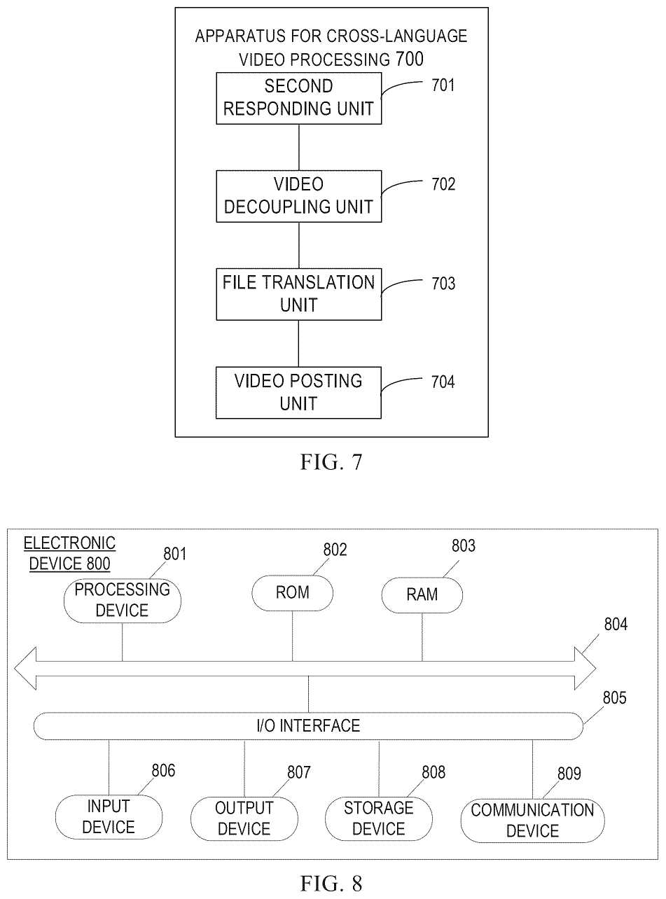

FIG. 7 is a schematic structural diagram of an embodiment of an apparatus for cross-language video processing according to an embodiment of the present disclosure. The apparatus for cross-language video processing may comprises:
a second responding unit 701 configured to, in response to a video posting request by a second user, determine a video to be posted;
a video decoupling unit 702 configured to decouple the video to be posted, to obtain an original audio file and a video file;
a file translation unit 703 configured to convert the original audio file into a translation file based on a respective language type of at least one language type, to obtain at least one translation file;
a video posting unit 704 configured to posting the video file, the original audio file and the at least one translation file, to store the at least one translation file in a server matching the respective language type corresponding to the at least one translation file; and
wherein the video file and a target translation file of the at least one translation file are used for synchronous play in response to a cross-language video processing request by a first user, and the target translation file matches a play demand of the first user.

As an embodiment, the video posting unit comprises:
a region determining module configured to determine a language application region corresponding to a respective translation file of the at least one translation file, according to the language type corresponding to the respective translation file;
a service querying module configured to query a server associated with the language application region corresponding to the respective translation file; and
a file sending module configured to send the respective translation file to the server associated with the corresponding language application region.

The apparatuses provided in the embodiments of the present disclosure may be configured to perform the technical solutions in the foregoing method embodiments, and implementation principles and technical effects thereof are similar, and details are not described herein again in these embodiments.

In order to implement the foregoing embodiments, the embodiments of the present disclosure further provide an electronic device, comprising: a processor and a memory. The memory stores computer-executable instructions.

The processor executes the computer-executable instructions stored in the memory, causing the processor to perform the method of cross-language video processing according to any of the foregoing embodiments.

The device provided in this embodiment may be configured to perform the technical solutions in the foregoing method embodiments, and implementation principles and technical effects thereof are similar, and details are not described herein again in this embodiment.

FIG. 8 shows a schematic structural diagram of an electronic device 800 suitable for implementing the embodiments of the present disclosure, and the electronic device 800 may be a terminal device or a server. The terminal device may include, but is not limited to, a mobile terminal such as a mobile phone, a notebook computer, a digital broadcast receiver, a personal digital assistant (PDA), a portable android device (PAD), a portable media player (PMP), an in-vehicle terminal (for example, an in-vehicle navigation terminal), and a fixed terminal such as a digital TV, a desktop computer, or the like. The electronic device shown in FIG. 8 is merely an example, and should not impose any limitation on the functions and scope of use of the embodiments of the present disclosure.

As shown in FIG. 8, the electronic device 800 may include a processing device (for example, a central processing unit, a graphics processing unit, or the like) 801, which may perform various appropriate actions and processing according to a program stored in a read only memory (ROM) 802 or a program loaded into a random access memory (RAM) 803 from a storage device 808. In the RAM 803, various programs and data required by the operation of the electronic device 800 are also stored. The processing device 801, the ROM 802, and the RAM 803 are connected to each other through a bus 804. An input/output (I/O) interface 805 is also connected to the bus 804.

Generally, the following devices may be connected to the I/O interface 805: an input device 806 including, for example, a touch screen, a touch pad, a keyboard, a mouse, a camera, a microphone, an accelerometer, a gyroscope, or the like; an output device 807 including, for example, a liquid crystal display (LCD), a speaker, a vibrator, or the like; a storage device 808 including, for example, a magnetic tape, a hard disk, or the like; and a communication device 809. The communication device 809 may allow the electronic device 800 to communicate wirelessly or wired with other devices to exchange data. While FIG. 8 shows an electronic device 800 having various devices, it should be understood that it is not required to implement or have all illustrated devices. More or fewer devices may alternatively be implemented or provided.

In particular, according to an embodiment of the present disclosure, the processes described above with reference to the flowchart may be implemented as a computer software program. For example, the embodiments of the present disclosure include a computer program product comprising a computer program carried on a computer readable medium. The computer program comprises program code for performing the method shown in the flowchart. In such embodiments, the computer program may be downloaded and installed from the network through the communication device 809, or installed from the storage device 808, or from the ROM 802. When the computer program is executed by the processing apparatus 801, the foregoing functions defined in the method of the embodiments of the present disclosure are performed.

It should be noted that the computer-readable medium described above may be a computer readable signal medium, a computer readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing. In the present disclosure, the computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such a propagated data signal may take a variety of forms including, but not limited to, an electromagnetic signal, an optical signal, or any suitable combination of the foregoing. The computer readable signal medium may further be any computer readable medium other than a computer readable storage medium that may send, propagate, or transmit a program for use by or in connection with an instruction execution system, apparatus, or device. The program code contained in the computer-readable medium may be transmitted with any suitable medium, including, but not limited to: a wire, an optical cable, radio frequency (RF), and the like, or any suitable combination of the foregoing.

An embodiment of the present disclosure further provides a computer-readable storage medium, where the computer-readable storage medium stores computer-executable instructions which, when executed by a processor, implement the method of cross-language video processing according to any of the foregoing embodiments.

An embodiment of the present disclosure further provides a computer program product comprising a computer program, where the computer program is executed by a processor to configure the method of cross-language video processing according to any of the foregoing embodiments.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, including object-oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to a user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowcharts or block diagrams may represent a module, program segment, or a portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in a reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of the unit in some cases does not constitute a limitation on the unit itself, for example, the first obtaining unit may further be described as a “unit for obtaining at least two Internet Protocol addresses”.

The functions described above may be performed, at least in part, by one or more hardware logic components. For example, without limitation, example types of hardware logic components that may be used include: a field programmable gate array (FPGA), an application specific integrated circuit (ASIC), an application specific standard product (ASSP), a system-on-a-chip (SOC), a complex programmable logic device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In a first aspect, the method of cross-language video processing is provided according to one or more embodiments of the present disclosure, comprising:
in response to a video playing request by a first user, determining a video to be played, the video to be played being a video posted by a second user;
determining a video file associated with the video to be played, and at least one translation file, the at least one translation file being obtained based on an original audio file of the video to be played being translated according to a respective language type of at least one language type, and the original audio file and the video file being obtained by decoupling the video to be played;
determining a target translation file matching play demand information of the first user, according to the respective language type corresponding to the at least one translation file; and
downloading the target translation file from a target server corresponding to the target language type, and synchronously playing the video file and the target translation file.

According to one or more embodiments of the present disclosure, determining the target language type matching the play demand information of the first user, according to the respective language type corresponding to the at least one translation file comprises:
displaying the at least one language type on a playing interface of the video to be played; and
in response to selecting by the first user on the at least one language type, obtaining the target language type selected by the first user.

According to one or more embodiments of the present disclosure, determining the target language type matching the play demand information of the first user, according to the respective language type corresponding to the at least one translation file comprises:
determining an application language of the first user according to user information of the first user; and
determining the target language type as a language type of the application language, according to the respective language type corresponding to the at least one translation file.

According to one or more embodiments of the present disclosure, the translation file comprises a track audio file, and determining the video file associated with the video to be played, and the at least one translation file comprises:
in accordance with a determination that the video to be played has multi-track playing permission, determining the video file associated with the video to be played, and at least one track audio file.

According to one or more embodiments of the present disclosure, the method further comprises:
displaying a multi-track switch on a playing interface of the video to be played; and
in response to triggering by the first user on the multi-track switch, determining that the video to be played has multi-track play permission, the multi-track play permission being used to enable playing permission of a track audio file of the video to be played, corresponding to a respective language type of the at least one language type.

According to one or more embodiments of the present disclosure, further comprising before downloading the target translation file matching the target language type, from the target server corresponding to the target language type:
in accordance with a determination, by querying, that a target translation file corresponding to the target language type is stored in a local server, determining that the local server is the target server.

According to one or more embodiments of the present disclosure, the method further comprises before downloading the target translation file from the target server corresponding to the target language type:
querying at least one server associated with the target language type of the video to be played; and
determining, from the at least one server, a target server with a minimum transmission distance from the first user.

According to one or more embodiments of the present disclosure, downloading the target translation file from the target server corresponding to the target language type comprises:
determining, according to the target server, a target download address of the video to be played, corresponding to the target language type; and
downloading the target translation file using the target download address.

According to one or more embodiments of the present disclosure, downloading the target translation file and synchronously playing the video file and the target translation file comprises:
determining at least one translation file segment of the target translation file matching the target language type and a segment order corresponding to a respective translation file segment of the at least one translation file segment;
sequentially downloading, by precaching, the translation file segment based on the segment order of the respective translation file segment;
coupling the downloaded translation file segment to a video file segment corresponding to the video file to obtain a target video segment, the downloaded translation file and the video file segment having a same timestamp; and
playing the target video segment to synchronously play the translation file segment in the target translation file and the video file segment in the video file.

In a second aspect, the method of cross-language video processing is provided according to one or more embodiments of the present disclosure, comprising:
in response to a video posting request by a second user, determining a video to be posted;
decoupling the video to be posted, to obtain an original audio file and a video file;
converting the original audio file into a translation file based on a respective language type of at least one language type to obtain at least one translation file;
posting the video file, the original audio file and the at least one translation file, to store the at least one translation file in a server matching the respective language type corresponding to the at least one translation file; and
wherein the video file and a target translation file of the at least one translation file are used for synchronous play in response to a cross-language video processing request by a first user, and the target translation file matches a play demand of the first user.

According to one or more embodiments of the present disclosure, storing the at least one translation file in the server matching the respective language type corresponding to the at least one translation file comprises:
determining a language application region corresponding to a respective translation file of the at least one translation file, according to the language type corresponding to the respective translation file;
querying a server associated with the language application region corresponding to the respective translation file; and
sending the respective translation file to the server associated with the corresponding language application region.

In a third aspect, an apparatus for cross-language video processing is provided according to one or more embodiments of the present disclosure, comprising:
a first responding unit configured to, in response to a video playing request by a first user, determine a video to be played, the video to be played being a video posted by a second user;
a file determining unit configured to determine a video file associated with the video to be played, and at least one translation file, the at least one translation file being obtained based on an original audio file of the video to be played being transmitted according to a respective language type of at least one language type, and the original audio file and the video file being obtained by decoupling the video to be played;
a language matching unit configured to determine a target translation file matching play demand information of the first user, according to the respective language type corresponding to the at least one translation file; and
a file processing unit configured to download the target translation file from a target server corresponding to the target language type, and synchronously play the video file and the target translation file.

In a fourth aspect, an apparatus for cross-language video processing is provided according to one or more embodiments of the present disclosure, comprising:
a second responding unit configured to, in response to a video posting request by a second user, determine a video to be posted;
a video decoupling unit configured to decouple the video to be posted, to obtain an original audio file and a video file;
a file translation unit configured to convert the original audio file into a translation file based on a respective language type of at least one language type, to obtain at least one translation file;
a video posting unit configured to posting the video file, the original audio file and the at least one translation file, to store the at least one translation file in a server matching the respective language type corresponding to the at least one translation file; and
wherein the video file and a target translation file of the at least one translation file are used for synchronous play in response to a cross-language video processing request by a first user, and the target translation file matches a play demand of the first user.

In a fifth aspect, an electronic device is provided according to one or more embodiments of the present disclosure, comprising: a processor and a memory;
the memory storing computer-executable instructions;
the processor executing the computer-executable instructions stored in the memory, causing the processor to implement the method of cross-language video processing according to the first aspect and various possible designs of the first aspect.

In a sixth aspect, a computer-readable storage medium is provided according to one or more embodiments of the present disclosure, where the computer-readable storage medium stores computer-executable instructions which, when executed by a processor, implement the method of cross-language video processing according to the first aspect and various possible designs of the first aspect.

In a seventh aspect, a computer program product is provided according to one or more embodiments of the present disclosure, comprising a computer program, wherein the computer program is executed by a processor to implement the method of cross-language video processing according to the first aspect and various possible designs of the first aspect.

The above description is merely an illustration of the preferred embodiments of the present disclosure and the principles of the applied technology. It should be understood by those skilled in the art that the protection scope in the present disclosure is not limited to the technical solutions of the specific combination of the above technical features, and should also cover other technical solutions formed by any combination of the above technical features or their equivalent features without departing from the above disclosed concept, for example, technical solutions formed by substituting the aforementioned features with technical features that have similar functions to those disclosed (but not limited to) in the present disclosure.

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Some features described in the context of separate embodiments may also be implemented in combination in a single embodiment. Conversely, the various features described in the context of a single embodiment may also be implemented in multiple embodiments individually or in any suitable sub-combination.

Although the present subject matter has been described in language specific to structural features and/or method logic acts, it is to be understood that the subject matter defined in the appended claims is not necessarily limited to the specific features or acts described above. Rather, the specific features and acts described above are merely example forms of implementing the claims.

1. A method of cross-language video processing, comprising:
in response to a video playing request by a first user, determining a video to be played, the video to be played being a video posted by a second user;
determining a video file associated with the video to be played, and at least one translation file, the at least one translation file being obtained based on an original audio file of the video to be played being translated according to a respective language type of at least one language type, and the original audio file and the video file being obtained by decoupling the video to be played;
determining a target translation file matching play demand information of the first user, according to the respective language type corresponding to the at least one translation file; and
downloading the target translation file from a target server corresponding to the target language type, and synchronously playing the video file and the target translation file.

2. The method of claim 1, wherein determining the target language type matching the play demand information of the first user, according to the respective language type corresponding to the at least one translation file comprises:
displaying the at least one language type on a playing interface of the video to be played; and
in response to selecting by the first user on the at least one language type, obtaining the target language type selected by the first user.

3. The method of claim 1, wherein determining the target language type matching the play demand information of the first user, according to the respective language type corresponding to the at least one translation file comprises:
determining an application language of the first user according to user information of the first user; and
determining the target language type as a language type of the application language, according to the respective language type corresponding to the at least one translation file.

4. The method of claim 1, wherein the translation file comprises a track audio file, and
determining the video file associated with the video to be played, and the at least one translation file comprises:
in accordance with a determination that the video to be played has multi-track playing permission, determining the video file associated with the video to be played, and at least one track audio file.

5. The method of claim 4, further comprising:
displaying a multi-track switch on a playing interface of the video to be played; and
in response to triggering by the first user on the multi-track switch, determining that the video to be played has multi-track play permission, the multi-track play permission being used to enable playing permission of a track audio file of the video to be played, corresponding to a respective language type of the at least one language type.

6. The method of claim 1, further comprising before downloading the target translation file matching the target language type, from the target server corresponding to the target language type:
in accordance with a determination, by querying, that a target translation file corresponding to the target language type is stored in a local server, determining that the local server is the target server.

7. The method of claim 1, further comprising before downloading the target translation file from the target server corresponding to the target language type:
querying at least one server associated with the target language type of the video to be played; and
determining, from the at least one server, a target server with a minimum transmission distance from the first user.

8. The method of claim 1, wherein downloading the target translation file from the target server corresponding to the target language type comprises:
determining, according to the target server, a target download address of the video to be played, corresponding to the target language type; and
downloading the target translation file using the target download address.

9. The method of claim 1, wherein downloading the target translation file and synchronously playing the video file and the target translation file comprises:
determining at least one translation file segment of the target translation file matching the target language type and a segment order corresponding to a respective translation file segment of the at least one translation file segment;
sequentially downloading, by precaching, the translation file segment based on the segment order of the respective translation file segment;
coupling the downloaded translation file segment to a video file segment corresponding to the video file to obtain a target video segment, the downloaded translation file and the video file segment having a same timestamp; and
playing the target video segment to synchronously play the translation file segment in the target translation file and the video file segment in the video file.

10. A method of cross-language video processing, comprising:
in response to a video posting request by a second user, determining a video to be posted;
decoupling the video to be posted, to obtain an original audio file and a video file;
converting the original audio file into a translation file based on a respective language type of at least one language type to obtain at least one translation file;
posting the video file, the original audio file and the at least one translation file, to store the at least one translation file in a server matching the respective language type corresponding to the at least one translation file; and
wherein the video file and a target translation file of the at least one translation file are used for synchronous play in response to a cross-language video processing request by a first user, and the target translation file matches a play demand of the first user.

11. The method of claim 10, wherein storing the at least one translation file in the server matching the respective language type corresponding to the at least one translation file comprises:
determining a language application region corresponding to a respective translation file of the at least one translation file, according to the language type corresponding to the respective translation file;
querying a server associated with the language application region corresponding to the respective translation file; and
sending the respective translation file to the server associated with the corresponding language application region.

12-13. (canceled)

14. An electronic device, comprising: a processor and a memory;
the memory storing computer-executable instructions;
the processor executing the computer-executable instructions stored in the memory, causing the processor to configure acts comprising:
in response to a video playing request by a first user, determining a video to be played, the video to be played being a video posted by a second user;
determining a video file associated with the video to be played, and at least one translation file, the at least one translation file being obtained based on an original audio file of the video to be played being translated according to a respective language type of at least one language type, and the original audio file and the video file being obtained by decoupling the video to be played;
determining a target translation file matching play demand information of the first user, according to the respective language type corresponding to the at least one translation file; and
downloading the target translation file from a target server corresponding to the target language type, and synchronously playing the video file and the target translation file.

15-16. (canceled)

17. The electronic device of claim 14, wherein determining the target language type matching the play demand information of the first user, according to the respective language type corresponding to the at least one translation file comprises:
displaying the at least one language type on a playing interface of the video to be played; and
in response to selecting by the first user on the at least one language type, obtaining the target language type selected by the first user.

18. The electronic device of claim 14, wherein determining the target language type matching the play demand information of the first user, according to the respective language type corresponding to the at least one translation file comprises:
determining an application language of the first user according to user information of the first user; and
determining the target language type as a language type of the application language, according to the respective language type corresponding to the at least one translation file.

19. The electronic device of claim 14, wherein the translation file comprises a track audio file, and
determining the video file associated with the video to be played, and the at least one translation file comprises:
in accordance with a determination that the video to be played has multi-track playing permission, determining the video file associated with the video to be played, and at least one track audio file.

20. The electronic device of claim 19, further comprising:
displaying a multi-track switch on a playing interface of the video to be played; and
in response to triggering by the first user on the multi-track switch, determining that the video to be played has multi-track play permission, the multi-track play permission being used to enable playing permission of a track audio file of the video to be played, corresponding to a respective language type of the at least one language type.

21. The electronic device of claim 14, further comprising before downloading the target translation file matching the target language type, from the target server corresponding to the target language type:
in accordance with a determination, by querying, that a target translation file corresponding to the target language type is stored in a local server, determining that the local server is the target server.

22. The electronic device of claim 14, further comprising before downloading the target translation file from the target server corresponding to the target language type:
querying at least one server associated with the target language type of the video to be played; and
determining, from the at least one server, a target server with a minimum transmission distance from the first user.

23. The electronic device of claim 14, wherein downloading the target translation file from the target server corresponding to the target language type comprises:
determining, according to the target server, a target download address of the video to be played, corresponding to the target language type; and
downloading the target translation file using the target download address.

24. The electronic device of claim 14, wherein downloading the target translation file and synchronously playing the video file and the target translation file comprises:
determining at least one translation file segment of the target translation file matching the target language type and a segment order corresponding to a respective translation file segment of the at least one translation file segment;
sequentially downloading, by precaching, the translation file segment based on the segment order of the respective translation file segment;
coupling the downloaded translation file segment to a video file segment corresponding to the video file to obtain a target video segment, the downloaded translation file and the video file segment having a same timestamp; and
playing the target video segment to synchronously play the translation file segment in the target translation file and the video file segment in the video file.
